(19) United States
(12) Patent Application Publication
(10) Pub. No.: US 2007/0285794 A1
(43) Pub. Date: Dec. 13, 2007

(54) Combined Image Transmitting System For A Motor Vehicle

(76) Inventor: Joel Fournier, Cergy (FR)

Correspondence Address: FOLEY & LARDNER LLP, 777 EAST WISCONSIN AVENUE, MILWAUKEE, WI, 53202-5306, US

(21) Appl. No.: 10/591,563

(22) PCT Filed: Mar. 3, 2005
(86) PCT No.: PCT/FR05/00501

§ 371 Date: Jun. 21, 2007

(30) Foreign Application Priority Data
Mar. 3, 2004 (FR) 0402192

(51) Int. Cl. G02B 27/01

(52) U.S. Cl. 359/630

(57) ABSTRACT

A motor vehicle instrument cluster includes an instrument panel in two parts at least arranged on either side of a semi-reflecting window and respectively generally at right-angles and generally parallel to the axis of vision.

### CROSS-REFERENCE TO RELATED PATENT APPLICATIONS

The present application is a National Stage of Application PCT/FR2005/000501 entitled, “Combined Image Transmitting System for a Motor Vehicle” filed on Mar. 3, 2005, which claims priority to French Patent Application No. FR 0402192 filed on Mar. 3, 2004, the disclosures of which are incorporated herein by reference in their entirety. Priority is claimed to these applications under 35 U.S.C. §§ 371 and 119, respectively.

### BACKGROUND

The invention relates to motor vehicle instrument clusters including a standard instrument cluster or instrument panel mounted in a dashboard behind a semi-reflecting window through which the driver can see the panel and which reflects toward the driver the image of a component (display, dial, etc.) mounted above the window, in the visor of the dashboard, center-stack console, or below, near the steering column.

Such instrument clusters have the disadvantage of occupying much space and requiring a thicker dashboard visor than car manufacturers would wish or causing an installation problem due to the steering column which prevents lowering of the instrument cluster.

In addition, since the number of parameters to be displayed increases with the vehicle's control functions, the display area continues to grow, but remains limited to that of the instrument cluster, i.e. fitted between the visor and the steering column.

Instrument clusters have already been proposed including displays on the lower part of the top of the dashboard and made visible to the driver by reflection of its image on the window of the instrument cluster, suitably inclined. But displays requiring much space cannot be installed there. The top of the dashboard would then become less attractive.

Instrument clusters have also been proposed including displays on the lower surface of the instrument cluster and made visible to the driver by reflection of its image on the window of the instrument cluster, inclined in the opposite direction from that of the previous solution. But, in that case also, because of the steering column, displays requiring much space cannot be installed.

Besides the fact that the lateral space required for an instrument cluster in the dashboard is less restricted, which allows additional displays of whatever size to be fitted sideways in it, the lateral part of the instrument panel can form a light box for the frontal part of the instrument cluster, and even form a sight obstruction for the passenger seated beside the driver.

### SUMMARY

It is thus that this application relates to a motor vehicle instrument cluster comprising an instrument panel in two parts at least arranged on either side of a semi-reflecting window and respectively generally at right-angles and generally parallel to the axis of vision. The part of the instrument panel generally parallel to the axis of vision lies sideways to the frontal part of the instrument panel at right-angles to the axis of vision.

One exemplary embodiment relates to a motor vehicle instrument cluster, including an instrument panel in two parts, the two parts at least arranged on either side of a semi-reflecting window and the two parts generally at right-angles with respect to the instrument panel and generally parallel to an axis of vision. A part of the instrument panel is generally parallel to the axis of vision which lies sideways to a front part of the instrument panel configured at a right-angle with respect to the axis of vision.

In a preferred embodiment of the instrument cluster, the frontal part of the instrument panel is surrounded by two lateral parts generally parallel to the axis of vision.

Advantageously, the semi-reflecting window includes at least one inclined semi-reflecting portion over the two parts of the instrument panel and one portion parallel to the frontal part of the instrument panel.

Preferably, the window of the instrument cluster is in one piece.

Another exemplary embodiment relates to an instrument cluster for a vehicle, including at least one reconfigurable display configured to selectively show at least two sets of information. The reconfigurable display includes: (i) a first display configured to show a first set of information; and (ii) a second display configured to show a second set of information. The first display is mounted in the instrument cluster perpendicular a direction of travel. The second display is mounted at an angle greater than one degree with respect to the first display. A reflective member is configured to reflect images from second display in a manner to show the second set of information in the direction of travel.

Another exemplary embodiment relates to a reconfigurable display for a vehicle, including a first display configured to show a first set of information; and a second display configured to show a second set of information. The first display is mounted perpendicular a direction of travel. The second display is mounted at an angle greater than one degree with respect to the first display. A reflective member is configured to reflect images from the second display in a manner to show the second set of information in the direction of travel.

Another exemplary embodiment relates to an instrument panel, including: a first display; and a second display positioned at an angle with respect to the first display. The first display and second display are configured to display information to a vehicle occupant in a space that at least partially overlaps in an axis of vision of the vehicle occupant.

### BRIEF DESCRIPTION OF THE DRAWINGS

The invention will be better understood with the help of the following description of the preferred embodiment of the instrument cluster, with reference to the accompanying drawings, in which:

FIG. 1 is a front view, of the instrument cluster; and

FIG. 2 is a cross-sectional view of the instrument cluster along the line II-II of FIG. 1.

### DETAILED DESCRIPTION

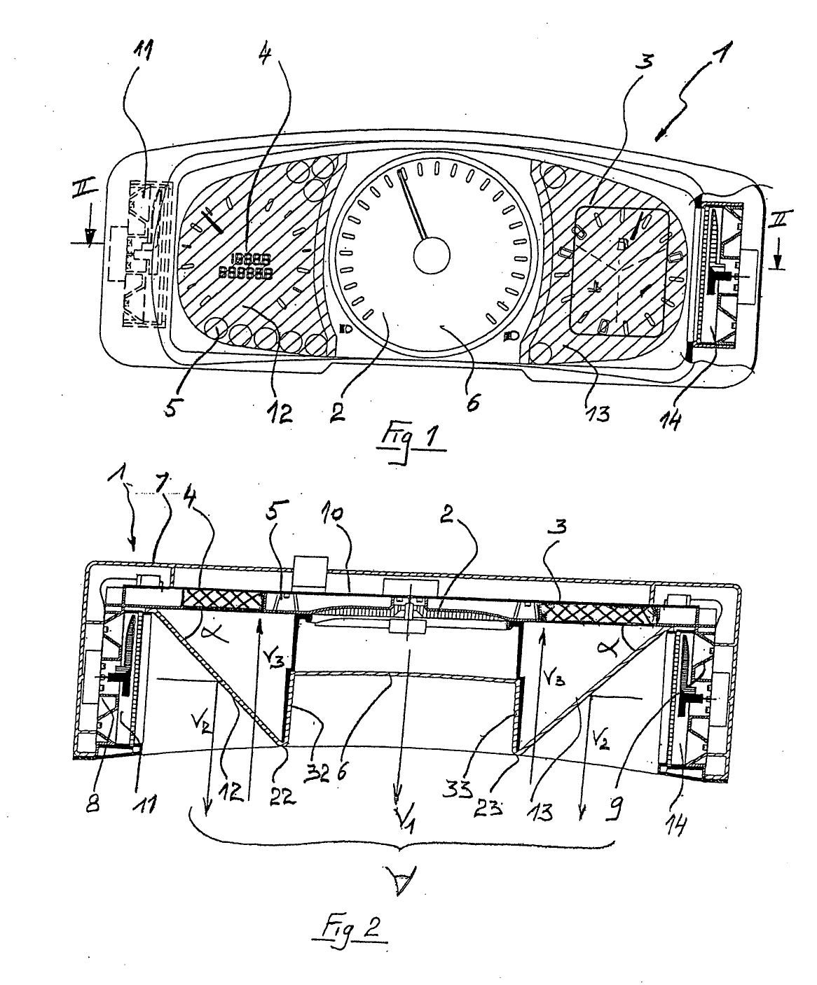

With reference to FIGS. 1-2, the instrument cluster 1 (or reconfigurable display) that will now be disclosed includes several parts including one frontal part 10; generally at right-angles to the axis of vision V1 (or direction of travel), in which a dial indicator 2, e.g., a speedometer; warning lights 5 and displays 3, 4, e.g., of LCD (liquid crystal display) type, have been fitted; two lateral parts generally parallel to the axis of vision V1, on the first portion 8 and second portion 9, in which dial indicators have been fitted; indicator 11 on the left; and a second indicator 14 on the right of the standard instrument panel.

The parts 8, 9, 10 of the instrument panel, and with them the on-board instruments including indicators (or displays) 2, 11, 14, warning lights 5 and the LCD displays 3, 4, are protected by a single semi-reflecting window 6, 12, and 13, described below.

First and second portion 8 and 9 are respectively generally at right-angles with respect to part 10 and parallel to the axis of vision V1 of the driver of the vehicle.

In addition, the parts of the instrument panel 8 and 10 on the one hand, and 9 and 10, on the other hand, are respectively arranged on either side of the parts 12 and 13 of the window.

Here, the parts 8 and 9 of the instrument panel lie sideways to the frontal part 10 of the instrument panel, extending from it.

The window, as shown in FIGS. 1-2 is in one piece and is formed of three parts, one frontal part 6 (or analogue display), and two lateral parts, on the left 12 and right 13. The window is arranged to protect the three parts of the instrument panel described above, respectively the parts 10, 8, and 9.

The window is also arranged to enable the on-board instruments to be viewed normally (or in front of the driver), whether they are arranged at right-angles or parallel to the axis of vision V1.

For this purpose, the left-hand lateral part 12 and right-hand lateral part 13 of the window are semi-reflecting and inclined at an angle α in relation to the frontal part 10 of the instrument panel so as to reflect toward the driver the image of instrument 11 or 14, arranged generally parallel to the axis of vision V1, along the optical path V2, of which a portion is perpendicular to the axis of vision and the other portion parallel to this axis.

In the instrument panel described herein, the frontal part 6 of the window is set back in relation to the forward edges 22, 23 of the inclined side parts 12, 13, of the window, to which it is connected by the window portions 32, 33 parallel to the axis of vision. The window therefore has here an irregular zigzag shape.

These parts of the window being semi-reflecting, they nevertheless allow the driver to see, in direct vision V3 through them, the displays and warning lights 3, 4, 5, or any other indicator which is arranged on the frontal part of the instrument panel, behind them.

The frontal part 6 of the window can also provide the same function in relation to any indicators or other instruments which are arranged in the top of the dashboard, its angle then being determined in relation to the horizontal plane of the dashboard and therefore to the axis of vision.

The fact that the free space at the lateral sides of the instrument cluster in the dashboard is not limited makes it possible to fit into it sideways additional displays of whatever size.

For example, the lateral parts of the instrument panel just disclosed can be used to create a light box for the frontal displays and hide these from the passenger seated beside the driver.

It should be understood that the construction and arrangement of the elements of the vehicle instrument cluster in the exemplary embodiments are illustrative only. Although several embodiments of the instrument cluster have been described in detail in this disclosure, many modifications are possible without materially departing from the novel teachings and advantages of the subject matter recited in the claims. Accordingly, all such modifications are intended to be included within the scope of the present vehicle as defined in the appended claims. Unless specifically otherwise noted, the claims reciting a single particular element also encompass a plurality of such particular elements. Moreover, claims reciting that one element is coupled to another should be interpreted to mean that the elements are selectively coupled to each other and may be uncoupled or disconnected at any point. Other substitutions, modifications, changes and/or omissions may be made in the design, operating conditions and arrangement of the preferred and other exemplary embodiments without departing from the spirit of the present invention as expressed in the appended claims.

1-6. (canceled)

7. A motor vehicle instrument cluster, comprising:
an instrument panel in two parts, the two parts at least arranged on either side of a semi-reflecting window and the two parts generally at right-angles with respect to the instrument panel and generally parallel to an axis of vision;
wherein a part of the instrument panel generally parallel to the axis of vision lies sideways to a front part of the instrument panel configured at a right-angle with respect to the axis of vision.

8. The instrument cluster of claim 7, wherein the front part of the instrument panel is surrounded by two lateral parts extending generally parallel to the axis of vision.

9. The instrument cluster of claims 7, wherein the semi-reflecting window includes at least one incline, semi-reflecting portion over the two parts of the instrument panel and one portion parallel to the front part of the instrument panel.

10. The instrument cluster of claim 9, wherein a portion of the semi-reflecting window is inclined with respect to the axis of vision.

11. The instrument cluster of claim 7, wherein the semi-reflecting window of the instrument cluster is in one piece.

12. The instrument cluster of claim 7, wherein the semi-reflecting window has a non-linear profile.

13. An instrument cluster for a vehicle, comprising:
at least one reconfigurable display configured to selectively show at least two sets of information, the reconfigurable display including:
(i) a first display configured to show a first set of information; and
(ii) a second display configured to show a second set of information;
wherein the first display is mounted in the instrument cluster perpendicular to a direction of travel, and wherein the second display is mounted at an angle greater than one degree with respect to the first display; and
a reflective member configured to reflect images from the second display in a manner to show the second set of information in the direction of travel.

14. The instrument cluster of claim 13, wherein the reflective member is positioned at about a 45 degree angle with respect to the second display.

15. The instrument cluster of claim 13, wherein the first display is an analogue display.

16. The instrument cluster of claim 15, wherein the second display is a digital display.

17. The instrument cluster of claim 16, wherein the second display is a display having a plurality of pixels arranged in columns and rows.

18. The instrument cluster of claim 16, wherein the second display is an LCD screen.

19. The instrument cluster of claim 13, wherein the reflective member includes a first end, a mid-portion and a second end, the first end positioned at an incline with respect to the direction of travel and the mid portion and second end are positioned in the direction of travel.

20. The instrument cluster of claim 19, wherein the mid portion is a fold between the first end and the second end and wherein the fold is at least partially transparent.

21. The instrument cluster of claim 20, wherein the fold is transparent with respect to light traveling opposite the direction of travel.

22. A reconfigurable display for a vehicle, comprising:
a first display configured to show a first set of information; and
a second display configured to show a second set of information;
wherein the first display is mounted perpendicular to a direction of travel, and wherein the second display is mounted at an angle greater than one degree with respect to the first display; and
a reflective member configured to reflect images from the second display in a manner to show the second set of information in the direction of travel.

23. The reconfigurable display of claim 22, wherein the reconfigurable display is a part of a vehicle instrument panel.

24. The reconfigurable display of claim 22, wherein the reconfigurable display is located in a vehicle center-stack console.

25. The instrument cluster of claim 24, wherein the reflective member includes a first end, a mid-portion and a second end, the first end positioned at an incline with respect to the direction of travel and the mid portion and second end are positioned in the direction of travel, and wherein the mid portion is a fold between the first end and the second end and wherein the fold is at least partially transparent.

26. The instrument cluster of claim 25, wherein the fold is transparent with respect to light traveling opposite the direction of travel.

27. An instrument panel, comprising:
a first display; and
a second display positioned at an angle with respect to the first display wherein the first display and second display are configured to display information to a vehicle occupant in a space that at least partially overlaps in an axis of vision of the vehicle occupant.

28. The instrument panel of claim 27, wherein the second display is an analogue display.

29. The instrument panel of claim 28, wherein the first display is a video display.

30. The instrument panel of claim 28, wherein the first display is positioned about perpendicular to an axis of vision of the vehicle occupant.
